(19) United States
(12) Patent Application Publication
(10) Pub. No.: US 2014/0150901 A1
(43) Pub. Date: Jun. 5, 2014

(54) PIEZO-ACTUATED PILOT VALVE

(71) Applicant: Parker-Hannifin Corporation, Cleveland, OH (US)

(72) Inventor: Steven Mark Mesner, Tomah, WI (US)

(21) Appl. No.: 13/909,820

(22) Filed: Jun. 4, 2013

Related U.S. Application Data
(60) Provisional application No. 61/655,055, filed on Jun. 4, 2012.

(51) Int. Cl. F16K 31/00

(52) U.S. Cl. CPC F16K 31/004
USPC 137/487.5

(57) ABSTRACT

A pilot valve includes a first port in selective fluid communication with a second port by a passageway through the valve; a valve seat; a movable piston selectively engagable with the valve seat to close the valve when the valve member engages the valve seat and to open the valve when the valve member is spaced from the valve seat; a pilot passageway providing a pathway to a portion of the piston opposite the side that engages the valve seat, the pathway being opened and closed by a pilot plug; and a piezo unit operable to control movement of the pilot plug to control whether the pathway is opened or closed.

### RELATED APPLICATIONS

This application claims the benefit of U.S. Provisional Application No. 61/655,055 filed Jun. 4, 2012, which is hereby incorporated herein by reference.

### FIELD OF INVENTION

The present invention relates generally to pilot operated valves, and more particularly to a pilot operated valve actuated by a piezoelectric actuator.

### BACKGROUND

Pilot-operated valves utilize system pressure to create force imbalances within the valve to open or close the main piston, or poppet, which in turn controls flow through the main port of the valve. Control of the pilot flow typically is done with a solenoid coil for on/off valves, or some type of pressure sensing device such as a spring-loaded diaphragm for pressure regulating control valves.

### SUMMARY OF INVENTION

Both of the conventional methods of controlling pilot operated valves have drawbacks. Solenoid, or on/off valves, utilize coils which consume large amounts of power and are unreliable over millions of cycles. Mechanically-operated pressure regulating valves are slow to respond, and are reactive to system pressure changes. Therefore, provided is a piezo-actuated pilot valve which takes advantage of the small compact size of piezo technology to control the pilot flow in pilot-operated valves. The piezo stack (or wafer) draws relatively low amounts of power. Exemplary piezo-actuated valves therefore can be operated by a relatively low voltage power supply, such as a battery or a solar cell. The piezo-actuated pilot valve also can have a programmable controller and/or can have an antenna that allows the valve to be controlled wirelessly.

According to one aspect of the invention, a pilot valve includes a first port in selective fluid communication with a second port by a passageway through the valve; a valve seat; a movable piston selectively engagable with the valve seat to close the valve when the valve member engages the valve seat and to open the valve when the valve member is spaced from the valve seat; a pilot passageway providing a pathway to a portion of the piston opposite the side that engages the valve seat, the pathway being opened and closed by a pilot plug; and a piezo unit operable to control movement of the pilot plug to control whether the pathway is opened or closed.

Optionally, the piezo unit is powered by a battery.

Optionally, the battery is a rechargeable battery.

Optionally, the pilot valve includes a solar panel electrically coupled to the battery for recharging the battery.

Optionally, the pilot valve includes a solar panel electrically coupled to the piezo unit for providing power to the piezo unit.

Optionally, the pilot valve includes an antenna for receiving a wireless signal.

Optionally, the valve is wirelessly controlled.

Optionally, the pilot valve includes a controller for controlling the piezo unit.

The foregoing and other features of the invention are hereinafter described in greater detail with reference to the accompanying drawings.

### BRIEF DESCRIPTION OF THE DRAWINGS

FIG. 1 is a cross-sectional view of an exemplary embodiment of a piezo-actuated pilot valve.

FIG. 2 is a cross-sectional view of another exemplary embodiment of a wireless piezo-actuated pilot valve.

### DETAILED DESCRIPTION

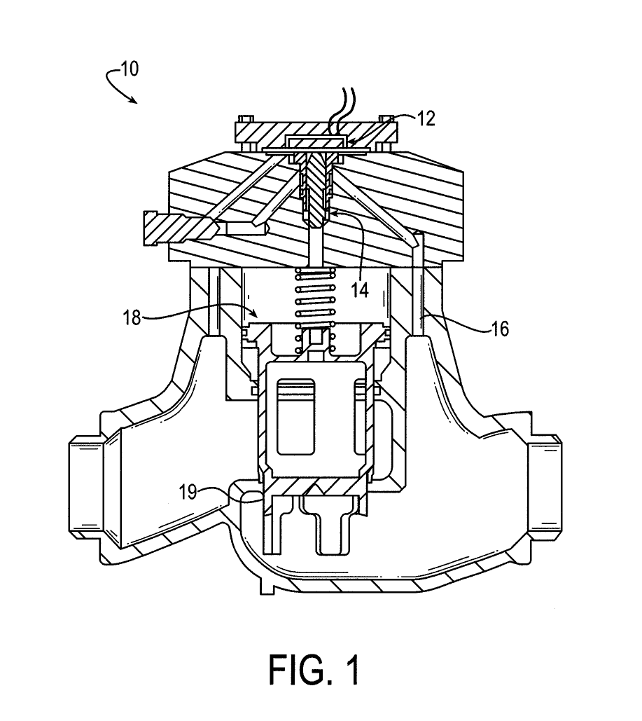

An exemplary embodiment of a piezo-actuated pilot valve 10 is shown in FIG. 1. The pilot valve 10 includes a first port 11 in selective fluid communication with a second port 13 by a passageway through the valve 10. A movable valve member (main piston plug) 18 is selectively engagable with the valve seat 19 to close the valve 10 when the valve member 18 engages the valve seat 19 and to open the valve 10 when the valve member 18 is spaced from the valve seat 19. A pilot passageway 16 provides a pathway to a portion of the valve member 18 opposite the side that engages the valve seat. The pathway is opened and closed by a pilot plug 14.

The valve 10 includes a smart material 12 operable to control movement of the pilot plug to control whether the pathway 16 is opened or closed. The smart material 12 may be, for example, a piezoelectric material. The stack 12 may also be referred to herein as a “wafer” or “piezo unit”. The piezo unit 12 controls movement of a pilot plug/cartridge 14, which can include a small mechanical pilot assembly which in turn controls the pilot flow via pilot passageway 16 to or from the main piston 18 or poppet of the valve. The main piston engages/disengages a valve seat 19 to open/close the valve. Controlling the pilot flow controls the pressure imbalances on the main piston/poppet, forcing it open or closed.

The piezo unit is a highly reliable, precise unit which draws very little power to operate. Power supply to these units is typically 12 or 24 volts with current draws less than one milliamp. The piezo unit can therefore be powered by a low power energy source, such as battery power, solar power, or another energy source. The movement of the piezo stack is proportional to the amount of energy that is supplied. The energy supplied can be full power for maximum movement to be used in on/off applications, or proportional from a controller based on feedback from any type monitoring system producing a 4-20 Ma or 0-10V signal. Thus, the piezo unit takes the place of large electrical coils, or mechanical pressure sensing devices such as springs.

The piezo unit should, preferably, be isolated or sealed away from the operating fluid, especially in refrigerant applications.

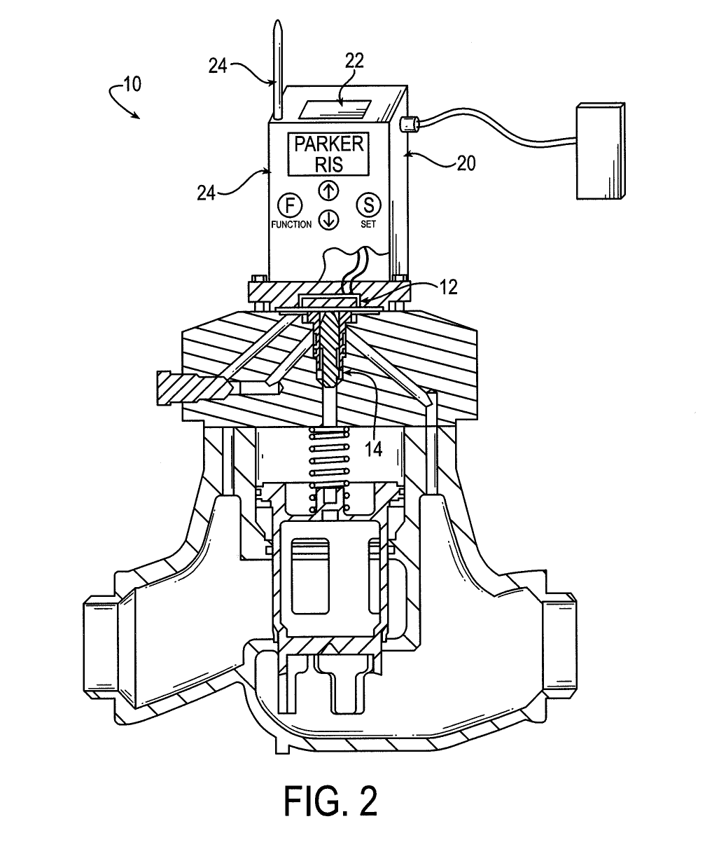

Because of the low power consumption of the piezo unit, it is possible for the unit to be powered by an on-board battery 20 integral to the valve assembly, as shown in FIG. 2.

Because many valves are located outside, the battery can be recharged through a solar panel 22 on the valve. Piezo units also give off electrical charges when they are moved, such as with the vibrations from piping; this may also be a means of collecting energy to keep the battery charged to operate the valve. Coupling this technology with wireless technology to send the valve control signals, the valve can be operated without any wires for power or control.

For example, as shown in FIG. 2, the pilot valve can include an antenna 20 for receiving a wireless signal for controlling the valve. Accordingly, the valve disclosed herein can be a totally wireless powered and actuated control valve, and can lead to energy savings from reduced power consumption to operate solenoid coil operated valves. The valve also may include a programmable controller 24 with, for example, one or more LEDs.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A pilot valve comprising:
a first port in selective fluid communication with a second port by a passageway through the valve;
a valve seat;
a movable valve member selectively engagable with the valve seat to close the valve when the valve member engages the valve seat and to open the valve when the valve member is spaced from the valve seat;
a pilot passageway providing a pathway to a portion of the valve member opposite the side that engages the valve seat, the pathway being opened and closed by a pilot plug; and
a piezo unit operable to control movement of the pilot plug to control whether the pathway is opened or closed,
wherein controlling pilot flow controls the pressure imbalances on the valve member, selectively engaging and disengaging the valve member with the valve seat.

2. The pilot valve of claim 1, wherein the piezo unit is powered by a battery.

3. The pilot valve of claim 2, wherein the battery is a rechargeable battery.

4. The pilot valve of claim 3, further comprising a solar panel electrically coupled to the battery for recharging the battery.

5. The pilot valve of claim 1, further comprising a solar panel electrically coupled to the piezo unit for providing power to the piezo unit.

6. The pilot valve of claim 1, further comprising an antenna for receiving a wireless signal.

7. The pilot valve of claim 6, wherein the valve is wirelessly controlled.

8. The pilot valve of claim 1, further comprising a controller for controlling the piezo unit.
